(19) United States
(12) Patent Application Publication
(10) Pub. No.: US 2009/0173846 A1
(43) Pub. Date: Jul. 9, 2009

(54) MEDICAL BOOM

(76) Inventor: Allan Katz, Freeport, NY (US)

Correspondence Address: Pearl Cohen Zedek Latzer, LLP, 1500 Broadway, 12th Floor, New York, NY, 10036, US

(21) Appl. No.: 11/971,589

(22) Filed: Jan. 9, 2008

(51) Int. Cl. F16M 13/00

(52) U.S. Cl. 248/124.1

(57) ABSTRACT

Embodiments of the present invention relate to a medical boom having sources and destinations, wherein all switching, converting, mixing, and image processing between the sources and the destinations may be performed by equipment integral to the medical boom. Embodiments of the processors may be specially designed to be mountable inside the medical boom. Embodiments of the present invention may result in more free space in an operating room, less cabling, lower costs, lower signal loss, less frame delay, and less need for processing of signals.

### BACKGROUND OF THE INVENTION

1. Field of the Invention

The present invention relates to a medical boom having sources and destinations. More specifically, the present invention relates to a medical boom having sources and destinations, wherein all switching, converting, mixing, and image processing between the sources and the destinations is performed by equipment housed within the medical boom.

2. Description of the Prior Art

The modern operating room requires an ever-increasing number of surgical instruments, monitoring and imaging devices, information systems, and communication networks. Similarly, the number of medical staff in the operating room has dramatically increased. Therefore, operating rooms have become quite crowded, and every square inch of their floor space is valuable.

The lack of space is compounded by the fact that many hospitals were designed before the development of many of the medical devices that are now standard in today's operating room. Therefore, these hospitals' operating rooms are simply not large enough to accommodate all of the medical equipment and staff that are now necessary. However, even in newly designed hospitals or in hospitals renovating their surgical wards space is at a premium. The economics of the situation is simple; the more operating rooms a hospital has the more revenue-generating surgeries it can perform. For example, in dividing up a 6,600 square foot space a hospital may decide to build eleven 600 square foot operating rooms instead of ten 660 square foot operating rooms.

The modern operating room contains a wide variety of audio, video, and technology tools, such as video cameras, endoscopes, monitors, video recorders, microphones, voice recorders, imaging systems, etc. With delicate surgery for example, a high resolution video camera may be placed in or above the surgical area of the patient. The video from the camera is then transmitted to a large monitor, so that the surgeon and medical staff can see an enlarged, detailed view of the surgical area. The enlarged, detailed view makes it easier for the surgeon to operate compared to relying on the naked eye.

To accommodate all the audio, video, and medical equipment, and to relieve the crowded floor space, many operating rooms have been built or retrofitted to include one or more medical booms. A medical boom is defined by Merriam-Webster dictionary as a long more or less horizontal supporting arm or brace. In most cases, a medical boom consists of an arm or arms mounted to the ceiling, which support various devices. A medical boom may also be a device with a base which supports articulating arms. A boom may be suspended from the ceiling, attached to the floor, or capable of being wheeled into and out of the operating room. Medical booms are also known as Equipment Management Systems, Ceiling Service Units, Equipment Carriers, Equipment Delivery Systems, and Equipment Booms. Audio, video, and medical equipment may be attached to or located in the articulating arms of the boom. The articulating arms may be moved into virtually any position around the operating table thereby allowing maximum utility and flexibility for the medical staff. Medical booms also centralize the electric and gas lines needed for this equipment and provide the ability to bring these lines in through the floor or ceiling so they do not take up floor space.

Thus, medical booms, particularly those suspended from the ceiling, save space in the operating room by taking valuable equipment off the floor and suspending it in the air. However, much of the space-saving economy of a medical boom is lost when the signals from the sources to the destinations must be processed by a processor. Commercially available processors are large pieces of equipment (typically over 1.5″ high, 19″ across, and between 1″ and 19″ deep) that are designed to be mounted into a standard 19″ rack system. Due to the sheer size and bulkiness of the rack system, rack systems are usually located away from the medical boom either in a far corner of the operating room or placed in special closets adjacent to the operating room.

When using a processor mounted in a rack system, there is no choice but to run the cables for the sources out of the medical boom and connect these cables to the inputs of the processor located in the rack. Cables must then be run from the outputs of the processor to connect to the destinations in the boom. Thus, when a processor is needed, significant changes must be made to the operating room. Valuable space in the operating room is now taken up by a large rack system housing the processor. Furthermore, the cabling requirements are now far more complicated and costly.

Thus, a system is needed that frees up valuable space in an operating room by eliminating the need for a large rack system while simplifying cabling requirements regardless of the number or type of video and audio equipment in the operating room.

### SUMMARY OF THE INVENTION

In an embodiment of the present invention a networked system may have a plurality of sources, a processor for processing signals from the sources, and a destination for receiving the processed signals. The networked system may also include a base supporting structure housing the processor. The networked system may further include a plurality of arms connected to the base supporting structure having the sources and the destination attached thereto.

In an embodiment of the present invention a network housed in a medical boom may include a plurality of video sources, wherein each video source is for producing a plurality of sequences of video frames. The network may further include a processor for receiving the plurality of sequences of video frames and transmitting a processed sequence of video frames from at least one of the video sources. The network may further include a video destination for receiving the transmitted sequence of video frames, wherein a delay between the production of the sequence of video frames and the receiving of the transmitted sequence of video frames is less than 2 frames.

In an embodiment of the present invention a processing system housed in a medical boom may include a plurality of sources for producing a plurality of signals. The processing system may further include a processor for receiving the plurality of signals and transmitting a processed signal from one at least one of the sources. The processing system may further include a destination for receiving the transmitted signal, wherein no additional processing occurs between the production of the signal by the one of the sources and the receiving of the transmitted signal by the destination.

In an embodiment of the present invention a network housed in a medical boom may include a first source for transmitting a first signal having a first signal type. The network may further include a second source for transmitting a second signal having the first signal type. The network may further include a first destination for receiving a signal having the first signal type and for receiving a signal having the second signal type. The network may further include a first switch for receiving the first signal and the second signal and selectively transmitting either the first signal or the second signal to the first destination.

### BRIEF DESCRIPTION OF THE DRAWINGS

Embodiments of the invention will be understood and appreciated more fully from the following detailed description in conjunction with the figures, which are not to scale, in which like reference numerals indicate corresponding, analogous or similar elements, and in which:

FIG. 1 shows an exemplary prior art system with a medical boom having sources and destinations which are connected to one or more processors mounted in a rack system;

FIG. 2A shows a block diagram of an exemplary prior art system according to FIG. 1 showing a network of two sources and two destinations attached to a medical boom and one processor mounted in a rack system;

FIG. 2B shows a block diagram of an exemplary prior art system according to FIG. 1 showing a network of four sources and two destinations attached to a medical boom and three processors mounted in a rack system;

FIG. 2C shows a block diagram of an exemplary prior art system according to FIG. 1 showing a network of four sources and two destinations attached to a medical boom and two processors mounted in a rack system;

FIG. 3 shows an embodiment of the present invention with a medical boom having sources and destinations which are connected to one or more processors mounted in the medical boom;

FIG. 4 shows a block diagram of an embodiment of the present invention according to FIG. 3 showing a network of four sources and two destinations attached to a medical boom and two inventive processors located in the medical boom;

FIG. 5 shows an exemplary prior art operating room with a medical boom having sources and destinations and a rack system having processors; and

FIG. 6 shows an operating room having a medical boom according to an embodiment of the present invention, the medical boom having sources, destinations, and processors therein.

### DESCRIPTION OF THE PREFERRED EMBODIMENT

Embodiments of the present invention relate to a medical boom having any number of networked sources and destinations, wherein all processing, such as switching, converting, mixing, and image processing, between the sources and the destinations is performed by equipment housed within the medical boom. A “source” is any piece of equipment that transmits a signal. A “destination” is any piece of equipment that receives a signal. A single piece of equipment may be capable of both transmitting a signal and receiving a signal. The portion of this piece of equipment that generates a signal is known as a “source” and the portion of this piece of equipment that receives a signal is known as a “destination”. A “signal” is any type of waveform useful for conveying information. A “cable” is any medium useful for conveying a signal between a source and a destination.

A “switch” is a piece of equipment to which two or more sources and one or more destinations are connected. The switch is capable of selectively connecting one of the sources to a destination. For example, a switch may be connected to Source A, Source B, and Destination Z. The switch may selectively connect either Source A or Source B to Destination Z. The switch may also preferentially disconnect any or all sources from the destination. A switch may be connected to Source A, Source B, Destination Y, and Destination Z. Such a switch may be a matrix switch. A matrix switch is capable of connecting any of the sources to any of the destinations, wherein in a regular switch only certain sources may be connected to certain destinations.

A “converter” is a piece of equipment to which one or more sources and one or more destinations are connected. A converter converts from a first signal type to a second, different, signal type. For example, a converter may convert a signal type used by a source to a signal type used by a destination. A converter may be a scaler useful for converting between different resolutions and aspect ratios. A converter may be a scanconverter useful for converting between video formats. A converter may be an analog to digital converter or a digital to analog converter.

A “mixer” is a piece of equipment to which two or more audio sources and one audio destination are connected. A mixer combines two or more audio input signals from the sources into an audio output signal to the destination. A mixer allows for separate adjustment to each audio input signal. For example, a mixer is capable of adjusting an audio input signal's gain or frequency response.

An “image processor” is a piece of equipment to which two or more video sources and one video destination are connected. An image processor combines two or more video input signals from the sources into a video output signal to the destination. An image processor allows for picture in picture, split screen, and quad screen.

The term “processing” refers to switching, converting, mixing, or image processing a signal. “Processing” may also refer to altering a characteristic of a signal or a destination of a signal. For example, a processor may be a signal booster or amplifier that increases a gain of a signal. The term “processor” may refer to a switch, a converter, a mixer, an image processor, or any device that processes a signal.

A signal may be an electromagnetic signal such as a light signal, a radio frequency signal, an electrical signal, or a magnetic signal, or may be an acoustic signal such as sound. A signal may be analog or digital.

A non-exhaustive list of possible signal types includes Composite (CVBS) in a format such as NTSC, SECAM, or PAL; S-Video (Y/C) in a format such as NTSC, SECAM, or PAL; RGBS, RGB (RGsB), or YUV in a format such as NTSC, SECAM, PAL, 480i, 480p, 720i, 720p, 1080i, or 1080p; SDI in a format such as NTSC, SECAM, PAL, 480i, 480p, 720i, 720p, 1080i, or 1080p; RGBHV (Analog RGB) in a format such as 480i, 480p, 720i, 720p, 1080i, 1080p, 640×480 VGA, 800×600 SVGA, 1024×768 XGA, 1280×1024 SXGA, 1400×1050 SXGA+, 1600×1200 UXGA, 1920×1400 TXGA, 2048×1536 QXGA, 2560×2048 QSXGA, 3200×2400 QUXGA, 5120×4096 HSXGA, 6400×4800 HUXGA, 1280×768, 1366×768 WXGA, 1440×900 WXGA+, 1920×1080, 1680×1050 WSXGA, 1920×1200 WUXGA, 2560×1600 WQXGA, 2800×2100 QSXGA+, 3200×2048 WQXSGA, 3200×2048 WQSXGA, 3840×2400 WQUXGA, 4096×2160 Sony 4K, 6400×4096 WHSXGA, or 7680×4800 WHUXGA; DVI (Digital RGB) or HDMI in a format such as 480i, 480p, 720i, 720p, 1080i, 1080p, 640×480 VGA, 800×600 SVGA, 1024×768 XGA, 1280×1024 SXGA, 1400×1050 SXGA+, 1600×1200 UXGA, 1920×1400 TXGA, 2048×1536, QXGA, 2560×2048 QSXGA, 3200×2400 QUXGA, 5120×4096 HSXGA, 6400×4800 HUXGA, 1280×768, 1366×768 WXGA, 1440×900 WXGA+, 1920×1080, 1680×1050 WSXGA, 1920×1200 WUXGA, 2560×1600 WQXGA, 2800×2100 QSXGA+, 3200×2048 WQXSGA, 3200×2048 WQSXGA, 3840×2400 WQUXGA, 4096×2160 Sony 4K, 6400×4096 WHSXGA, or 7680×4800 WHUXGA; and audio in a format such as analog or digital.

A non-exhaustive list of possible sources includes an endoscope, a surgical camera, a room camera, a surgical light camera, a CArms, a vital signs monitor, an echo, an ultrasound, a headlight camera, a microscope camera, an MRI imaging machine, a CT imaging machine, a computer, a hospital information system computer, a picture archiving and communication system computer, a robot such as a Da Vinci surgical system, an audio/video conferencing system, a CD player, a DVD player, a HD-DVD player, a Blue-ray player, a multi-image processor, a VCR, a DVCAM player, a tape player, a catheterization system, a pathology system, and a histology system.

A non-exhaustive list of possible destinations includes a monitor, a display, a computer, an audio/video conferencing system, a printer, a CD recorder, a DVD recorder, a HD-DVD recorder, a Blue-ray recorder, a VCR, a DVCAM recorder, a tape recorder, a digital capture system, a digital video recorder, and a multi-image processor.

A non-exhaustive list of possible cables includes coax, fiber optic, CAT5, HDMI, wireless, and audio cable.

In existing systems, if a processor is not necessary to process signals a rack system is not needed. For example, a medical boom may have a source and a destination with the same signal type. Because the source and destination use the same signal type, a processor is not needed. The source may be directly connected to the destination such that all cabling is located within the boom.

Presently available commercially available processors are designed to fit within a 19″ rack system and are typically over 1.5″ high, 19″ across, and between 1″ and 19″ deep. This size is simply too large to fit within a medical boom. A medical boom may typically have an internal cross-sectional area of no more than 8″ by 8″ and may have an even smaller cross-sectional area once gas lines and electrical wiring is added.

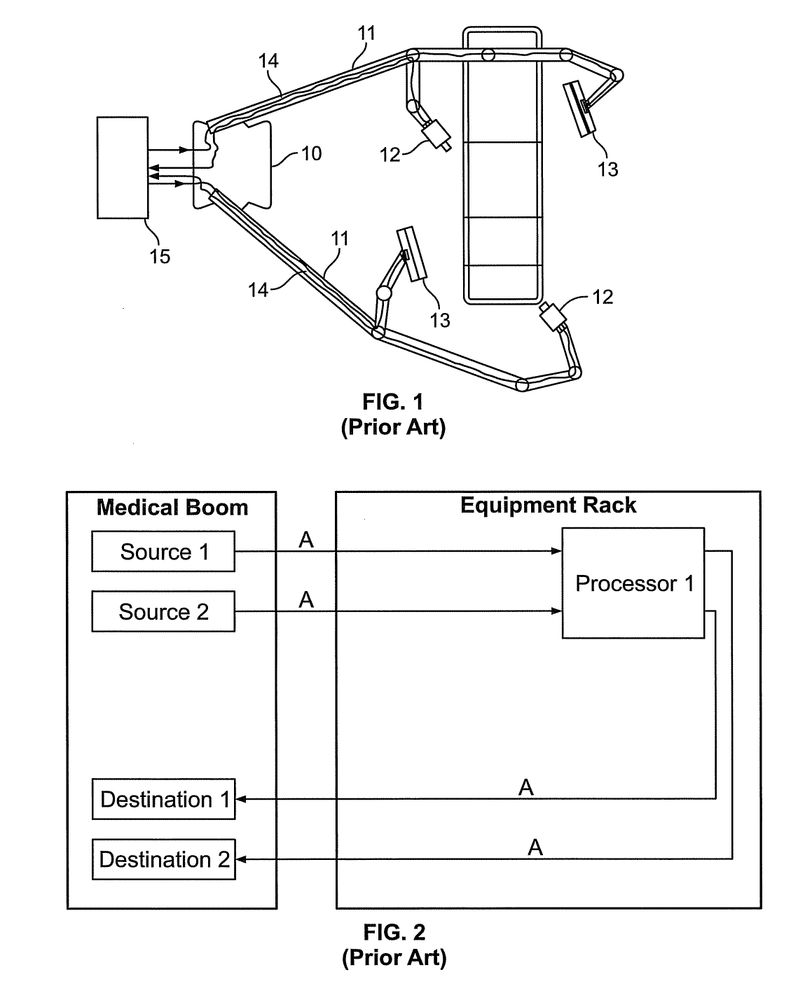

Therefore, in existing systems, if a processor is necessary to process signals from one or more sources to one or more destinations, a rack system is needed as well to house the processors. For example, if the medical boom contains two sources and one destination with the same signal type, a switch is needed to selectively connect either the first source or the second source to the destination. As another example, if a source and destination use incompatible signal types, a converter is needed to convert to a common signal type. As discussed earlier, existing processors are large devices which are mounted in a rack system. Thus, when a processor is needed, there is no choice but to run the cables for the sources out of the medical boom and connect these cables to the inputs of a processor located in the rack system. Cables must then be run from the outputs of the processor to connect to the destinations in the boom. Such a system is shown in FIG. 1.

FIG. 1 shows an exemplary prior art system with a medical boom having sources and destinations which are connected to one or more processors mounted in a rack system. The medical boom has a base 10 with attached articulating arms 11. Attached to the articulating arms are sources 12 and destinations 13. The signals from the sources and the signals to the destinations are transmitted by cables 14. In the prior art system shown in FIG. 1, the signals are carried by the cables to and from one or more processors mounted in a rack system 15. Because the processors are located in the rack system away from the medical boom, in order to connect the sources and destinations to the processors, the cables must exit and enter the boom and extend to the processors in the rack system. The rack system typically stands on the floor and has a sizeable footprint of 22″ by 26″. As discussed, this takes up valuable real estate in the operating room.

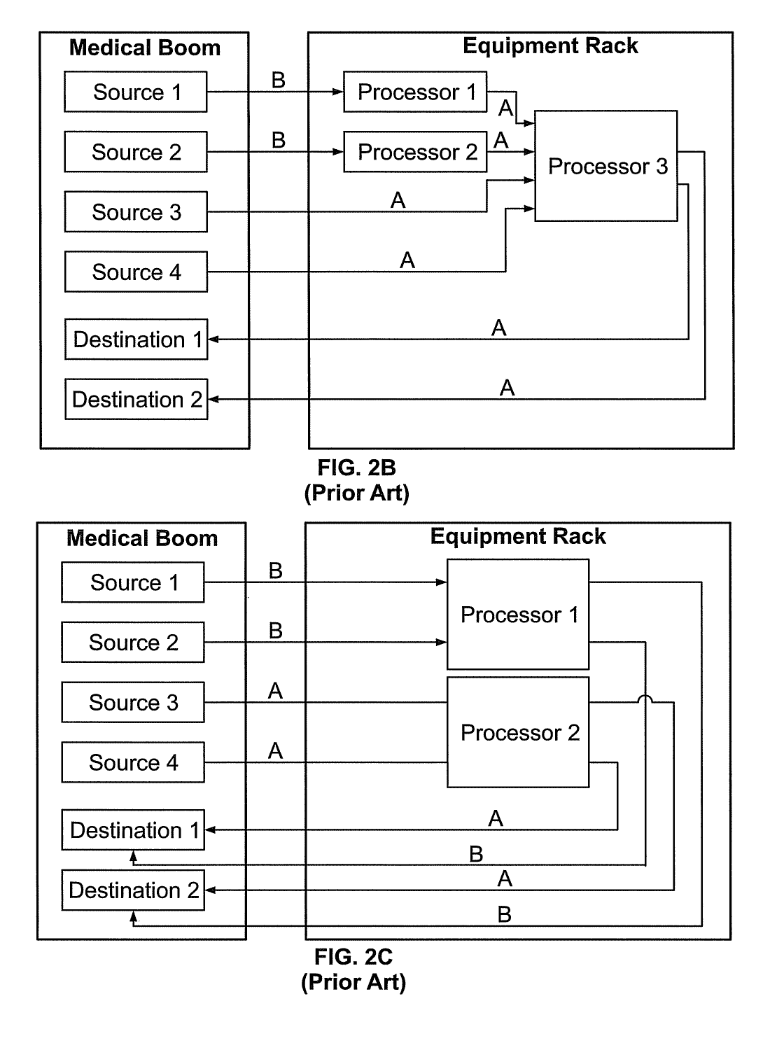

FIG. 2A shows a block diagram of an exemplary prior art system according to FIG. 1 showing a network of two sources and two destinations attached to a medical boom and one processor mounted in a rack system. Source 1 and Source 2 may be a High-Definition video camera such as a Sony® EVI-HD1 which has an HD-SDI signal type output. Destination 1 and Destination 2 may be a High-Definition monitor such as a National Display Systems Radiance® 42 HD which has an HD-SDI signal type input. A switch is needed to selectively connect either Source 1 or Source 2 to either Destination 1 or Destination 2. Processor 1 may be an HD-SDI matrix switch such as a Kramer® 88 HD which has 8 HD-SDI signal type inputs and 8 HD-SDI signal type outputs. In this prior art system, two cables connect Source 1 and Source 2 in the medical boom to the inputs of Processor 1 in the rack system and two cables connect the outputs of Processor 1 in the rack system to Destination 1 and Destination 2 in the medical boom.

FIG. 2B shows a block diagram of an exemplary prior art system according to FIG. 1 showing a network of four sources and two destinations attached to a medical boom and three processors mounted in a rack system. Source 1 and Source 2 may be a High-Definition video camera such as a Sony® BRC-H700 which has an analog Y/Pb/Pr signal type output. As in the system shown in FIG. 2A, Source 3 and Source 4 may be a High-Definition video camera such as a Sony® EVI-HD1 which has an HD-SDI signal type output. As in the system shown in FIG. 2A, Destination 1 and Destination 2 may be a High-Definition monitor such as a National Display Systems Radiance® 42 HD which has an HD-SDI signal type input. In order to selectively connect any of Source 1 through Source 4 to either Destination 1 or Destination 2 with a single switch it is necessary to convert all signal types to a common signal type. One way of doing this is to convert the analog Y/Pb/Pr signal types from Source 1 and Source 2 to an HD-SDI signal type which is supported by Source 3, Source 4, Destination 1, and Destination 2. Processor 1 and Processor 2 may be an analog Y/Pb/Pr to HD-SDI converter such as a Lux Media Plan® HD 10AD converter. As in the system shown in FIG. 2A, Processor 3 may be an HD-SDI matrix switch such as a Kramer® 88 HD which has 8 HD-SDI signal type inputs and 8 HD-SDI signal type outputs. In this prior art system, two cables connect Source 1 and Source 2 in the medical boom to the inputs of Processor 1 and Processor 2 in the rack system and two cables connect the outputs of Processor 1 and Processor 2 in the rack system to the inputs of Processor 3 in the rack system. Two cables connect the outputs of Source 3 and Source 4 in the medical boom to the inputs of Processor 3 in the rack system, and two cables connect the outputs of Processor 3 in the rack system to Destination 1 and Destination 2 in the medical boom.

FIG. 2C shows a block diagram of an exemplary prior art system according to FIG. 1 showing a network of four sources and two destinations attached to a medical boom and two processors mounted in a rack system. As in the system shown in FIG. 2B, Source 1 and Source 2 may be a High-Definition video camera such as a Sony® BRC-H700 which has an analog Y/Pb/Pr signal type output. As in the system shown in FIG. 2B, Source 3 and Source 4 may be a High-Definition video camera such as a Sony® EVI-HD1 which has an HD-SDI signal type output. As in the system shown in FIG. 2B, Destination 1 and Destination 2 may be a High-Definition monitor such as a National Display Systems Radiance® 42 HD which has an HD-SDI signal type input and also an analog Y/Pb/Pr signal type input. A first switch is needed to selectively connect either Source 1 or Source 2 to either Destination 1 or Destination 2. Processor 1 may be an analog Y/Pb/Pr matrix switch such as a Lenexpo Electronics® SB-5588 which has 8 analog Y/Pb/Pr signal type inputs and 8 analog Y/Pb/Pr signal type outputs. A second switch is needed to selectively connect either Source 3 or Source 4 to either Destination 1 or Destination 2. Processor 2 may be an HD-SDI matrix switch such as a Kramer® 88 HD which has 8 HD-SDI signal type inputs and 8 HD-SDI signal type outputs. In this prior art system, two cables connect Source 1 and Source 2 in the medical boom to the inputs of Processor 1 in the rack system and two cables connect the outputs of Processor 1 in the rack system to the inputs of Destination 1 and Destination 2 in the medical boom. Two cables connect the outputs of Source 3 and Source 4 in the medical boom to the inputs of Processor 2 in the rack system and two cables connect the outputs of Processor 2 in the rack system to Destination 1 and Destination 2 in the medical boom.

A converter such as Processor 1 and Processor 2 in FIG. 2B typically imposes a delay of 2 or more frames between the source video stream at its inputs and the destination video stream at its outputs. Additionally, a converter typically degrades the quality of the signal while converting the input signal to the output signal. Lastly, a high quality converter is very expensive. Therefore, in existing systems, an approach more similar to that shown in FIG. 2C may be employed instead of the approach shown in FIG. 2B. However, in the system shown in FIG. 2C the cabling requirements are more cumbersome and expensive. For example, if a Source 5 is added which is identical to Source 3 and Source 4, three more cables must be added. One cable connects the output of Source 5 to the input of Processor 2 and two cables connect the output of Processor 2 to the inputs of Destination 1 and Destination 2. If instead a Destination 3 is added which is identical to Destination 1 and Destination 2, two cables must be added. One cable connects the output of Processor 1 to the input of Destination 3 and a second cable connects the output of Processor 2 to the input of Destination 3. It is not hard to see how quickly the cabling requirements grow for the system show in FIG. 2C.

Thus, in prior art systems a trade-off must be made by carefully weighing frame delay, signal integrity, cost, and cabling requirements. It is not possible using current methods and devices to have a network of sources, destinations, and processors with minimal frame delay, high signal integrity, low cost, and simple cable requirements.

Embodiments of the present invention relate to custom-designed processors, such as switches, converters, mixers, and image processors, which are miniaturized to fit within a medical boom. By way of example only, in the present invention an 8 source-by-8 destination matrix switch may be roughly 4″ high, 6″ across, and between 1″ and 2″ deep. Such a matrix switch may be mounted inside a medical boom.

An exemplary embodiment of an 8 source-by-8 destination matrix switch is an 8 source-by-8 destination S-video matrix switch. The inventive switch may use, for example, an Analog Devices® AD8114 225 MHz 16×16 crosspoint programmable switch. Alternatively, other switches may be used. The switch may be programmed, for example, by a Microchip® PIC18F4321 PIC microcontroller. Alternatively, other microcontrollers may be used. Typically, instructions may be sent to the microcontroller to control the switch by a RS-232 transceiver such as a Texas Instruments® MAX232E. Other transceivers may alternatively be used.

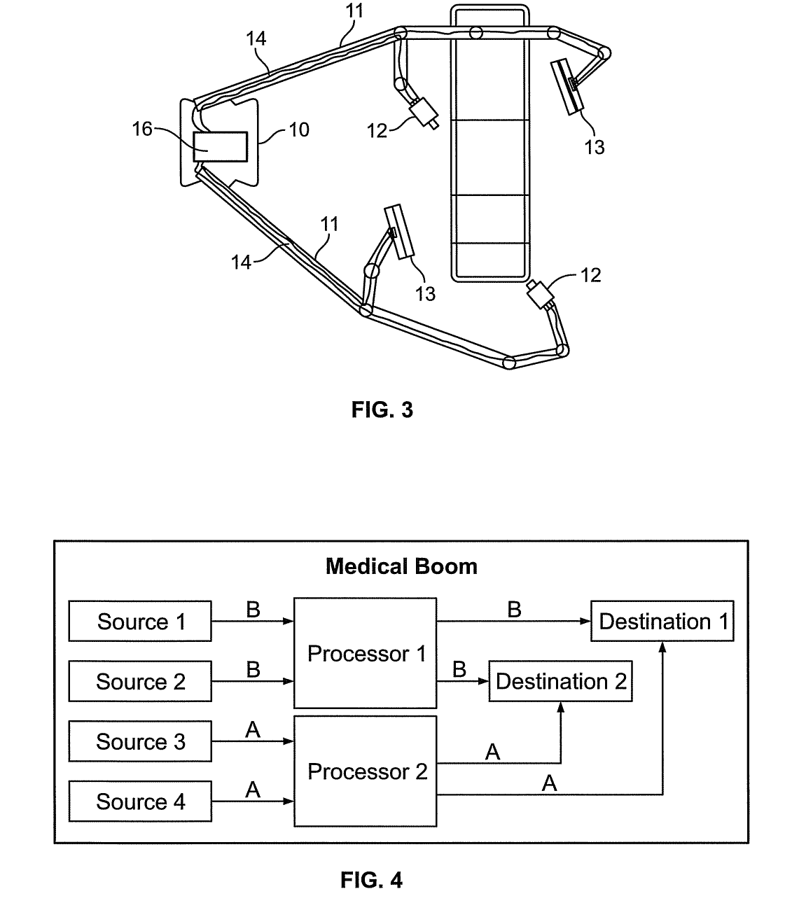

FIG. 3 shows an embodiment of the present invention in which a medical boom has a base 10 with attached articulating arms 11. The medical boom may be a Steris Harmony CS® Equipment Management System. Alternatively, the boom may be any medical boom such as those manufactured by Steris®, Skytron®, Berchtold®, or Getinge®. The boom may be attached to the ceiling. Alternately, the boom may be attached to the floor or capable of being wheeled in and out of the operating room. Attached to the articulating arms are sources 12 and destinations 13. The sources may be video cameras. The destinations may be monitors. The signals from the sources and the signals to the destinations are transmitted by cables 14. In the embodiment shown in FIG. 3, the signals are carried by the cables to a processor 16 which is housed within the medical boom. As is now possible for the first time, the processor of the disclosed invention is small enough to be located within the medical boom itself. Therefore, all processing may be performed within the medical boom thereby making the prior art systems shown in FIGS. 2B and 2C obsolete. In the inventive system it is typically no longer necessary to convert signals or have complicated cabling requirements.

FIG. 4 shows a block diagram of an embodiment of the present invention according to FIG. 3 showing a network of four sources and two destinations attached to a medical boom and two inventive processors located in the medical boom. Source 1 and Source 2 may be a High-Definition video camera such as a Sony® BRC-H700 which has an analog Y/Pb/Pr signal type output. Source 3 and Source 4 may be a High-Definition video camera such as a Sony® EVI-HD1 which has an HD-SDI signal type output. Destination 1 and Destination 2 may be a High-Definition monitor such as a National Display Systems Radiance® 42 HD which has an HD-SDI signal type input and also an analog Y/Pb/Pr signal type input. A first switch is needed to selectively connect either Source 1 or Source 2 to either Destination 1 or Destination 2. Processor 1 may be an inventive analog Y/Pb/Pr matrix switch according to an embodiment of the present invention which has 8 analog Y/Pb/Pr signal type inputs and 8 analog Y/Pb/Pr signal type outputs. A second switch is needed to selectively connect either Source 3 or Source 4 to either Destination 1 or Destination 2. Processor 2 may be an inventive HD-SDI matrix switch according to an embodiment of the present invention which has 8 HD-SDI signal type inputs and 8 HD-SDI signal type outputs. In this inventive system, two cables connect Source 1 and Source 2 in the medical boom to the inputs of Processor 1 in the medical boom and two cables connect the outputs of Processor 1 in the medical boom to the inputs of Destination 1 and Destination 2 in the medical boom. Two cables connect the outputs of Source 3 and Source 4 in the medical boom to the inputs of Processor 2 in the medical boom and two cables connect the outputs of Processor 2 in the medical boom to Destination 1 and Destination 2 in the medical boom.

Because the processors are located within the medical boom, it is no longer necessary to make trade-offs between frame delay, signal integrity, cost, and cabling requirements. In most cases, converters are not necessary. This results in minimal delay, greater signal integrity, reduced cost, and shorter and less complicated cabling. Because the cable lengths are far shorter, it is no longer cumbersome to add additional sources or destinations to the network. The shorter cables also reduce signal loss and, in most cases, eliminate the need for signal boosters. This further reduces cost and system complexity.

In an embodiment of the present invention, the inventive switches, converters, mixers, and image processors may not require any ventilation or active cooling methods. Contrastingly, nearly all comparable commercially available equipment requires ventilation and active cooling. A medical boom is not internally vented or cooled because no manufacturer has ever mounted equipment inside the boom. This is likely because of the stringent operating room requirements regarding airflow. Furthermore, if the medical boom were to be ventilated and cooled it may create an unsanitary environment in the operation room. Therefore, even if commercially available equipment could be made to fit within a medical boom, the equipment would soon overheat due to a lack of ventilation and cooling. Even worse, if ventilation and cooling were to be added to the medical boom to accommodate the commercially available equipment, an unsanitary environment would inadvertently be created.

In an embodiment of the present invention, a rack system is developed to mount the miniaturized switches, converters, mixers, and image processors within the medical boom. Although most medical booms have an internal electrical supply, a power supply may be provided as part of the inventive rack system.

In an embodiment of the present invention, the inventive switches, converters, mixers, and image processors may be certified as medical grade equipment. Contrastingly, no comparable commercially available equipment is certified as medical grade. Equipment that is not properly certified as medical grade should not be brought near an operating table.

In an embodiment of the present invention, the inventive switches, converters, mixers, and image processors may be controllable by an operator. For example, an operator may control an inventive switch to select which source is connected to which destination. The inventive processor may be controllable by means of a control panel on the medical boom or may be remotely controllable from a workstation connected to the medical boom. Control of the inventive processors may be by means of an RS-232 port, an Ethernet port, relay closures, or by wireless control.

Embodiments of the present invention have been found to offer a variety of benefits to the medical field beyond freeing up space in the operating room. As mentioned above, in prior art systems cables must be run from the sources in the medical boom to the equipment in the rack system and from the equipment in the rack system to the destinations in the medical boom. These cables must be run in large numbers of cable conduits. In embodiments of the present invention, however, because all switches, scalers, mixers, and image processors are located within the medical boom all cables are run internal to the medical boom as well. Thus, the length of cables is now far shorter than has ever been able to be achieved. Furthermore, the large number of cable conduits is no longer necessary. This not only leads to lower cable costs, but has significant ramifications in the operating room.

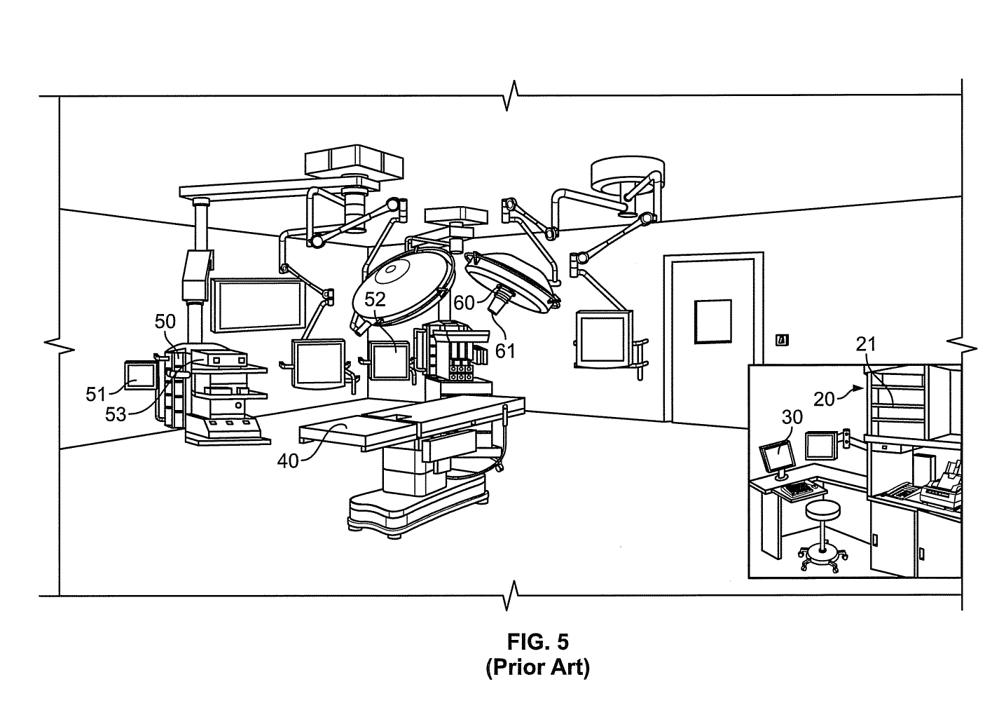

FIG. 5 shows an exemplary prior art operating room with a medical boom having sources and destinations and a rack system having processors. Processors 21 in rack system 20 are located near a Nurse's station 30 on the opposite side of the operating room from an operating table 40. A first medical boom 50 has a first monitor 51 mounted to a small arm and a second monitor 52 mounted to a monitor arm. The first medical boom also has a medical camera 53 mounted thereto. A surgical light camera 61 is mounted to a second boom 60. The nurse's station may have a control panel 31. Alternatively, the control panel may be located near the first monitor.

In order to calculate the length of cable needed, it is assumed that the distance from the sources or destinations on the first medical boom to the ceiling is 20 feet. It is assumed that the camera controller for the surgical light camera is already in the ceiling. It is assumed that the distance across the ceiling from the medical boom or the camera controller to the rack system is 40 feet. It is assumed that the distance from the ceiling down to the junction box in the rack system is 10 feet. Finally, it is assumed that the distance from the junction box to the processors in the rack system is 5 feet. Thus, the cable length from the processors in the rack to the sources and destinations in the first medical boom is 75 feet and the cable length from the processors in the rack to the camera controller in the ceiling is 55 feet. It is further assumed that an average of 5 feet of cable is needed to attach any two processors in the rack system. Lastly, it is assumed that in embodiments of the present invention an average of 5 feet of cable is needed to attach any two components (sources, destinations, or processors) located on the medical boom or attached to a small arm. However, 40 feet of cable is needed to connect a first component located on a monitor arm to a second component located on the medical boom or attached to a small arm (20 feet from the first component up to the ceiling and another 20 feet down to the second component).

Thus, in FIG. 5 the length of cable required between the medical camera on the first medical boom and the processors is approximately 75 feet. The length of cable required between the surgical light camera on the second boom and the processors is approximately 55 feet since the camera controller is already in the ceiling. The length of cabling between the processors and the first monitor on the first medical boom is approximately 75 feet. The length of cabling between the processors and the second monitor on the first medical boom is approximately 75 feet. If the control panel for the processors is located at the Nurse's station, the length of cable between the control panel and the processors is approximately 15 feet. If the control panel for the processors is located near the first monitor on the first medical boom, the length of cable between the control panel and the processors is approximately 75 feet.

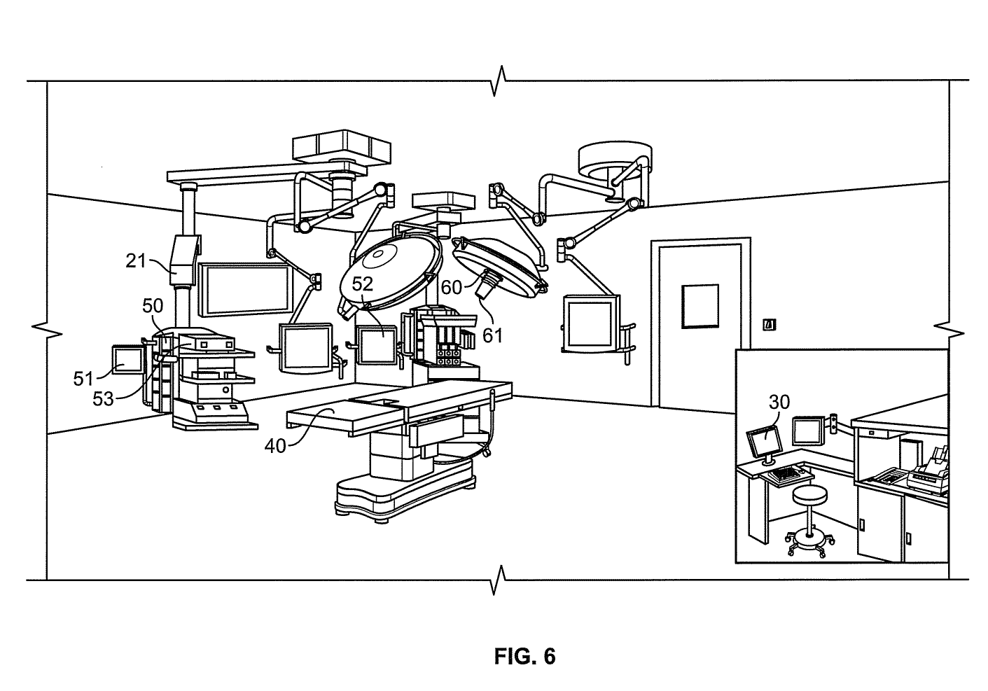

FIG. 6 shows an operating room having a medical boom according to an embodiment of the present invention, the medical boom having sources, destinations, and processors housed therein. As in FIG. 5, the nurse's station is located on the opposite side of the operating room from the operating table. The first medical boom has the first monitor mounted to the small arm and the second monitor mounted to the monitor arm. The first medical boom also has the medical camera mounted thereto. The surgical light camera is mounted to the second boom. The nurse's station may have the control panel. Alternatively, the control panel may be located near the first monitor. However, unlike in FIG. 5, in this embodiment of the present invention, the processors are mounted within the first medical boom.

Thus, in FIG. 6, the length of cable required between the medical camera and the processors in the first medical boom is approximately 5 feet. The length of cable required between the surgical light camera and the processors in the first medical boom is approximately 20 feet since the camera controller is in the ceiling. The length of cabling between the processors in the first medical boom and the first monitor on the small arm is approximately 5 feet. The length of cabling between the processors in the first medical boom and the second monitor on the monitor arm is approximately 40 feet. If the control panel for the processors is located at the Nurse's station, the length of cable between the control panel and the processors in the first medical boom is approximately 75 feet. If the control panel for the processors is located near the first monitor on the first medical boom, the length of cable between the control panel and the processors is approximately 5 feet.

In the prior art system depicted in FIG. 2B 460 feet of cable are needed. In the prior art system depicted in FIG. 2C 600 feet of cable are needed. As indicated above, the amount of cabling can grow quickly as more sources and destinations are added. Adding just one source outputting a different signal type and one destination increases the cable used to 1050 feet. If this system has six sources with four signal types and six destinations the amount of cable increases to 2,250 feet. If the rack system is located outside the operating room, which is fairly common, the length of cable could easily double. In contrast, in the inventive system depicted in FIG. 4 only 40 feet of cable are needed. If the inventive system is increased to six sources with four signal types and six destinations the amount of cable increases to only 150 feet.

Typically, the longer a cable, the more loss a signal carried over that cable will have at its destination. For example, the accepted limit for an HDMI cable is approximately 6 meters. The accepted limit for a composite video cable is approximately 8 meters. Thus, in prior art systems, since the distance between the medical boom and the rack system was always more than 8 meters, there was always a degree of signal loss in an HDMI or a composite video signal. In fact, a 720p signal sent from a source to a destination over more than 6 meters of cable will typically no longer be 720p certified when the signal reaches the destination. Additionally, a processor may degrade the signal as it processes it. For example, a converter may degrade a signal as it converts between a first signal type and a second signal type. This signal loss is not acceptable in an operating room when even the slightest loss in image quality can prevent a surgeon from operating properly or identifying certain tissues or pathology. In prior art systems, this necessitated the use of a signal booster or converter to prevent this type of degradation. It has been found that in embodiments of the present invention, no processing or boosting is necessary because the cabling lengths typically never exceed the maximum length specified for any signal type. A signal loss may be quantified by a signal to noise ratio. A signal loss may alternatively be quantified in terms of quality degradation. Lastly, a signal loss may be quantified in terms of a signal which had a signal type at a source no longer being certified at a destination as having that same signal type. It has been found that by locating all of the components of the present invention in the medical boom, a signal loss of heretofore unrealized quality is now achieved.

If a processor, such as a converter, is necessary, the operations performed by the processor require time to be performed. This delays the transmittal of the signal between the source and the destination. For example, typical frame delays in state-of-the-art prior art scalers are 2 frames or more. This can lead to dangerous situations in the operating room. For example, high resolution surgical cameras are often used by surgeons to see surgical areas not normally viewable. These images are displayed on large monitors allowing the surgeon to see an enlarged, detailed view of the surgical area. In fact, many surgeons do not even look at the surgical area as it is easier to operate by looking at the monitor. A delay in the transmittal of the video signal between the camera and the monitor can result in a frame delay such that what the surgeon is looking at on the monitor is not what is happening in “real time” but instead what happened a short while ago. Delays of even a few milliseconds can be incredibly disturbing and dangerous when a surgeon attempts to make an incision, for example, and is viewing what he or she just did instead of what he or she is doing currently. Components of the present invention when housed in a medical boom demonstrate a time delay that is or that approaches “real time” which is usable by a surgeon during an actual operation. This delay may be 0 frames, 2 frames or less, or 5 frames of less. This has not previously been able to be reliably achieved.

It is important to note that not all of the sources and destinations need to be attached to the medical boom. Sources and destinations external to the medical boom may be attached to the processor(s) located in the inventive medical boom by cables. This may further negate the need for a separate rack system that takes up valuable space in the operating room.

Although a variety of specific sources, destinations, processors, signal types, and cables are delineated herein, the present invention is not intended to be limited to these specific examples. Rather, the terms sources, destinations, processors, signal types, and cables are meant to encompass the full breadth of the definitions provided hereinabove.

What is claimed is:

1. A networked system having a plurality of sources, a processor for processing signals from the sources, and a destination for receiving the processed signals, comprising:
a) a base supporting structure housing the processor; and
b) a plurality of arms connected to said base supporting structure having the sources and the destination attached thereto.

2. The networked system of claim 1, wherein the processor is a switch.

3. The networked system of claim 1, wherein the processor is a converter.

4. The networked system of claim 1, wherein the processor is a mixer.

5. The networked system of claim 1, wherein the processor is an image processor.

6. A network housed in a medical boom, comprising:
a) a plurality of video sources, wherein each video source is for producing a plurality of sequences of video frames;
b) a processor for receiving said plurality of sequences of video frames and transmitting a processed sequence of video frames from at least one of said video sources; and
c) a video destination for receiving said transmitted sequence of video frames, wherein a delay between said production of said sequence of video frames and said receiving of said transmitted sequence of video frames is less than 2 frames.

7. The networked system of claim 6, wherein the processor is a switch.

8. The networked system of claim 6, wherein the processor is a converter.

9. The networked system of claim 6, wherein the processor is an image processor.

10. A processing system housed in a medical boom, comprising:
a) a plurality of sources for producing a plurality of signals;
b) a processor for receiving said plurality of signals and transmitting a processed signal from one at least one of said sources; and
c) a destination for receiving said transmitted signal,
wherein no additional processing occurs between said production of said signal by said one of said sources and said receiving of said transmitted signal by said destination.

11. The processing system of claim 10, wherein the processor is a switch.

12. The processing system of claim 10, wherein the processor is a converter.

13. The processing system of claim 10, wherein the processor is a mixer.

14. The processing system of claim 10, wherein the processor is an image processor.

15. The processing system of claim 10, wherein the plurality of sources are video sources.

16. The processing system of claim 10, wherein the plurality of sources are audio sources.

17. The processing system of claim 10, wherein the destination is a video source.

18. The processing system of claim 10, wherein the destination is an audio source.

19. A network housed in a medical boom, comprising:
a) a first source for transmitting a first signal having a first signal type;
b) a second source for transmitting a second signal having said first signal type;
c) a first destination for receiving a signal having said first signal type and for receiving a signal having said second signal type; and
d) a first switch for receiving said first signal and said second signal and selectively transmitting either said first signal or said second signal to said first destination.

20. The network of claim 19, further comprising:
e) a third source for transmitting a third signal having a second signal type;
f) a fourth source for transmitting a fourth signal having said second signal type;
g) a second destination for receiving a signal having said first signal type and for receiving a signal having said second signal type; and
h) a second switch for receiving said third signal and said fourth signal and selectively transmitting either said third signal or said fourth signal to said first destination or said second destination, wherein said first switch is for receiving said first signal and said second signal and selectively transmitting either said first signal or said second signal to said first destination or said second destination.
